(19) United States
(12) Patent Application Publication
(10) Pub. No.: US 2023/0132946 A1
(43) Pub. Date: May 4, 2023

(54) TICKET PRICE DETERMINATION APPARATUS, TICKET PRICE DETERMINATION METHOD, AND TICKET PRICE DETERMINATION PROGRAM

(71) Applicant: JVCKENWOOD Corporation, Yokohama-shi (JP)

(72) Inventor: Jiro UZAKI, Yokohama-shi (JP)

(21) Appl. No.: 17/931,914

(22) Filed: Sep. 14, 2022

(30) Foreign Application Priority Data
Oct. 28, 2021 (JP) 2021-176568

(51) Int. Cl. G06Q 30/02; G06Q 10/02

(52) U.S. Cl. CPC G06Q 30/0283; G06Q 10/02

(57) ABSTRACT

A database stores a value of an image filmed from a seat in a site where filming is permitted, mapping the value to the seat. A price variation monitoring unit monitors a variation in the value of the image filmed from the seat where filming is permitted. A price determination unit determines a price of a filming ticket associated with the seat where filming is permitted, in accordance with the variation in the value of the image filmed from the seat where filming is permitted. A seat recommendation unit recommends the seat where filming is permitted based on a density of filming persons in the site determined by a situation of purchase of filming ticket for the site or based on a condition of field of view determined by an obstacle in filming.

### BACKGROUND OF THE INVENTION

### 1. Field of the Invention

The present invention relates to a ticket price determination technology.

### 2. Description of the Related Art

Recently, imaging equipment are available in increasingly smaller sizes and exhibit increasingly higher resolutions. It has become possible for ordinary users to film and distribute a high-quality image by using the imaging equipment. It is also possible for users to share and distribute an image casually by using a social networking service (SNS). In this background, permission may be given to filming from a spectator's seat at a site of a live music concert or a drama in the future, allowing an image filmed by ordinary spectators to be distributed or sold over the Internet.

It is desired, for the benefit of both ticket sellers and purchasers, to configure a system for selling a ticket, which includes a seat ticket and a filming ticket for a site where filming is permitted, to recommend a seat suitable for filming by a purchaser by assessing the value of an image filmed from a seat objectively and reflecting it in the ticket price, and by making a prediction as to which seat allows filming a highly valuable image.

### SUMMARY OF THE INVENTION

The present invention addresses the above-described issue, and a purpose thereof is to provide a ticket price determination technology adapted to ticket sales for a site where filming is permitted and highly convenient for both ticket sellers and purchasers.

A ticket price determination apparatus according to an embodiment of the present invention includes: a database that stores a value of an image filmed from a seat in a site where filming is permitted, mapping the value to the seat; a price variation monitoring unit that monitors a variation in the value of the image filmed from the seat where filming is permitted; and a price determination unit that determines a price of a filming ticket associated with the seat where filming is permitted, in accordance with the variation in the value of the image filmed from the seat where filming is permitted.

Another embodiment of the present invention relates to a ticket price determination method. The method includes: referring to a database that stores a value of an image filmed from a seat in a site where filming is permitted, mapping the value to the seat, and monitoring a variation in the value of the image filmed from the seat where filming is permitted; and determining a price of a filming ticket associated with the seat where filming is permitted, in accordance with the variation in the value of the image filmed from the seat where filming is permitted.

Optional combinations of the aforementioned constituting elements, and implementations of the disclosure in the form of methods, apparatuses, systems, recording mediums, and computer programs may also be practiced as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 shows a configuration of a ticket price determination apparatus according to an embodiment;

FIG. 2 shows how various information managed by the database or the block chain is associated with each other;

FIG. 3 shows another example of event information;

FIG. 4 illustrates an NFT of a filming ticket linked to a seat;

FIG. 5 is a flowchart illustrating a procedure for ticket reservation;

FIG. 6A is a flowchart illustrating a detailed procedure of a step of FIG. 5 for checking the price of a ticket with a filming ticket, and FIG. 6B is a flowchart illustrating a detailed procedure of a step of FIG. 5 for checking the price of a ticket without a filming ticket; and

FIG. 7 is a flowchart illustrating a detailed procedure of a step of FIGS. 6A and 6B for calculating the filming ticket price.

### DETAILED DESCRIPTION OF THE INVENTION

The invention will now be described by reference to the preferred embodiments. This does not intend to limit the scope of the present invention, but to exemplify the invention.

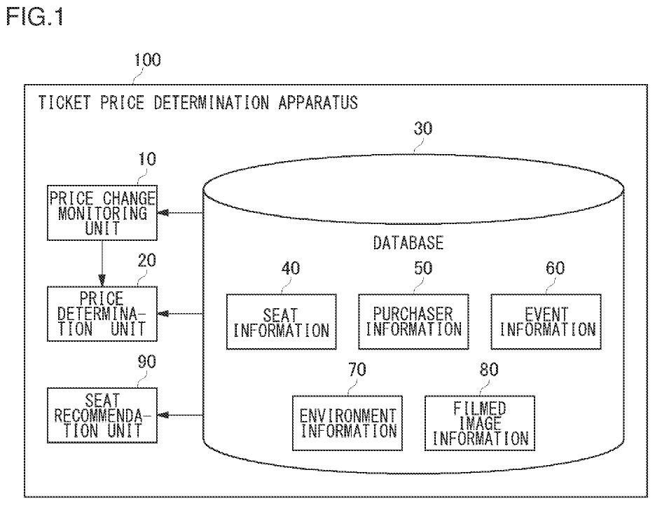

FIG. 1 shows a configuration of a ticket price determination apparatus 100 according to an embodiment. The ticket price determination apparatus 100 includes a price variation monitoring unit 10, a price determination unit 20, a database 30, and a seat recommendation unit 90.

The database 30 stores seat information 40, purchaser information 50, event information 60, environmental information 70, and filmed image information 80. Some of these information items may be managed in distributed management as non-fungible tokens (NFT) on a block chain instead of being managed by the database 30 in centralized management. NFT functions as digital data for filmed images and tickets with a certificate of ownership.

The seat information 40 includes positional relationship between a seat and the stage, information on how the stage looks from the seat, information on whether filming from the seat is permitted, a history of the price of the filming ticket associated with the seat, etc.

In the case filming from the purchased seat is permitted, the purchaser information 50 also represents information on a filming person who purchased the filming ticket of the seat and includes information related to the physique (e.g., height) of the purchaser of the seat, a history of selling prices of images sold and bought by the filming person, information on the camera equipment brought in by the filming person, etc.

The event information 60 incudes information on a filmed person such as a singer and an actor, information related to a program that will be a special element (e.g., a retirement ceremony) in the event, information (and a history) on a trend (popularity) associated with the filmed person, etc.

The environmental information 70 includes information on whether the site is indoors or outdoors, date and time when the event is held, weather of the date and time of the event, information on the illumination at the site, etc.

The filmed image information 80 includes the ownership of the image, filming date and time, filming location (filming site) and seat, information on filming equipment, history of the selling price of an image that is filmed (filmed images), etc.

The database 30 stores the value of an image filmed from the seat where filming is permitted, mapping the value to the seat.

When filmed images are managed by NFT in distributed management, inclusion of information on the seat and the filming equipment in the NFT in addition to the filming date and time and filming location lends a premium feel to the seat and the filming equipment and enhances the added value to the filmed image.

The price variation monitoring unit 10 monitors variation in the value of the image filmed from the seat where filming is permitted. Every time a filmed image is sold, information on the ownership and the selling price are added to and recorded in the filmed image information 80. The information may be recorded as NFT on a block chain in a distributed manner. The price variation monitoring unit 10 refers to the filmed image information 80 and, when a total of n filmed images are sold, calculates a total of the selling prices of the n filmed images as the value of the filmed images. The price variation monitoring unit 10 can calculate the value of the filmed image initially sold and the current value of the filmed image by referring to the history of the selling price of the filmed image and determine a situation of variation in the value (e.g., whether the value of the filmed image is increasing, decreasing, or remains mostly level). The price variation monitoring unit 10 monitors the variation in the value of the filmed image and notifies the price determination unit 20 of the situation of variation in the value.

The price determination unit 20 determines the price of the filming ticket associated with the seat where filming is permitted, in accordance with the situation of variation in the value of the image filmed from the seat where filming is permitted. The price of a ticket is a total of the price of the seat ticket and the price of the filming ticket.

The price of the seat ticket is determined by calculating the field-of-view occupancy based on the information on the other seats in the site that are purchased. The field-of-view occupancy represents how the stage looks when the stage is viewed from the seat and and is a measure indicating how extensive the occupied field of view is, as determined by the vacancy of seats. The field-of-view occupancy is set based on the height of the purchasers of the other seats, the positional relationship with the stage, etc. The larger the proportion occupied by the stage in the image filmed from the seat, the larger the field-of-view occupancy set.

The price of a seat ticket varies depending on the whether the site is an indoor site or an outdoor site, date and time of the event held, and environmental information such as weather and illumination. The environmental information may be fixed for each event.

In the seat information, the seat and information on a history of images filmed from the seat and sold and bought in the past are associated with each other. By referring to the seat information, it is possible to access information such as what kind of event has been filmed from the seat, what kind of image has been filmed, the price at which the image has been sold and bought, and how the price has varied. The price of the seat ticket of the seat can be determined by allowing for these items of information.

The filming ticket is associated with one or more seats, and the price of the filming ticket is dynamically determined by the seat information and the event information. The right price of the filming ticket is determined by evaluating the variation in the trend associated with the filmed person in addition to the history of the price of the filming ticket associated with the seat and the history of sales and purchase of the image filmed. In other words, the price of the filming ticket is weighted by the variation in the trend. In the presence of a trend variation that increases the price of the filming ticket, a weighting coefficient that increases the price of the filming ticket may be set.

The value of an image filmed at the seat is determined and predicted by referring to the variation in the trend associated with the filmed person, and the price of the filming ticket is determined accordingly. For example, the following elements are considered. In the case of an artist who is already famous, the image filmed is valued immediately, and a deal is concluded. In the case of new artists, new Olympic athletes, etc., a filmed image is traded in the long term and will have slowly increasing asset value. In the case there is a rumor of marriage or retirement by the end of the year, the asset value of the filmed image may rise abruptly and sharply. The right price of the filming ticket is determined by determining and predicting the variation in the value of the filmed image by referring to the variation in the trend. When it is predicted that the asset value of the filmed image will rise abruptly, the ticket may be sold in an auction format.

Further, the price of the filming ticket may be weighted by the program effect of the ticket sought to be purchased. The program effect means variation in the price of the filming ticket according to a program. For example, the price is set high due to the effect of announcement of a new song, retirement of the artist, etc. In other words, a weighting coefficient that increases the price of the filming ticket may be set in the case of a program for which it is predicted that the price of the filming ticket will be set high (e.g., in the case the number of occasions is limited, in the case of a performance or a match in which a filmed person who is expected to expose himself or herself less frequently in the future makes an appearance, etc.).

A user can reserve a ticket while checking the positional relationship between the seat and the stage in a three-dimensional presentation. By setting, at the time of reservation, the focal distance and magnification ratio of the camera equipment, translated into the 35 mm format, that the filming person brings in, the field angle that can be filmed by the camera can be checked in the three-dimensional presentation. The positional relationship between the seat and the stage need not necessarily be displayed in a three-dimensional presentation. It is sufficient that the purchaser (filming person) can understand the positional relationship between the seat and the stage.

It is also possible to understand beforehand the condition of the field of view determined by obstacle(s) in sight when the stage is filmed from the seat, by displaying a silhouette of the physique in the purchaser information on the purchaser who bought the ticket in a three-dimensional presentation.

It is also possible to simulate filming from the seat position by virtually arranging persons or musical instruments on the stage in a three-dimensional presentation as desired. Simulation of filming in which brightness and shadow are allowed for is also possible by setting stage illumination.

The seat recommendation unit 90 recommends a seat for which the value of filmed images is expected to be high, based on the density of filming persons in the site as determined by the situation of purchaser of filming tickets for the site or based on the condition of field of view as determined by an obstacle in the filming.

When a filming ticket it sold, the site may be organized into an area where filming is permitted and an area where filming is not permitted. Tickets may be sold such that one seat remains vacant in front of, behind, to the left of, and to the right of the seat where filming is permitted.

When the purchaser information on seats around a purchased seat is updated (e.g., when a user with a large physique purchases a seat in front of the purchased seat after the ticket is purchased), the seat recommendation unit 90 may calculate the field-of-view occupancy in accordance with an obstacle in the filming within the field of view from the purchased seat and may recommend changing the seat from the purchased seat to a seat in the same prize zone based on the field-of-view occupancy (e.g., when the field-of-view occupancy is equal to or less than a predetermined threshold value).

The seat recommendation unit 90 may recommend a seat with a high filming value based on the density of filming persons in the site (e.g., information indicating that filming persons who purchased filming tickets are concentrated in a particular area or a particular floor, information indicating that purchasers having the same equipment are near a vacant seat, etc.). When filming persons are concentrated in the right area, for example, the seat recommendation unit 90 may recommend a seat in the left area. When there are few filming persons in balcony seats, the seat recommendation unit 90 may recommend a balcony seat.

The purchaser attempting to reserve a ticket can refer to a sales history of images filmed from the seat in the past and check past and present prices.

The profit from the sales of a ticket can be shared by the organizer, site, artist who is filmed, or copyright owner.

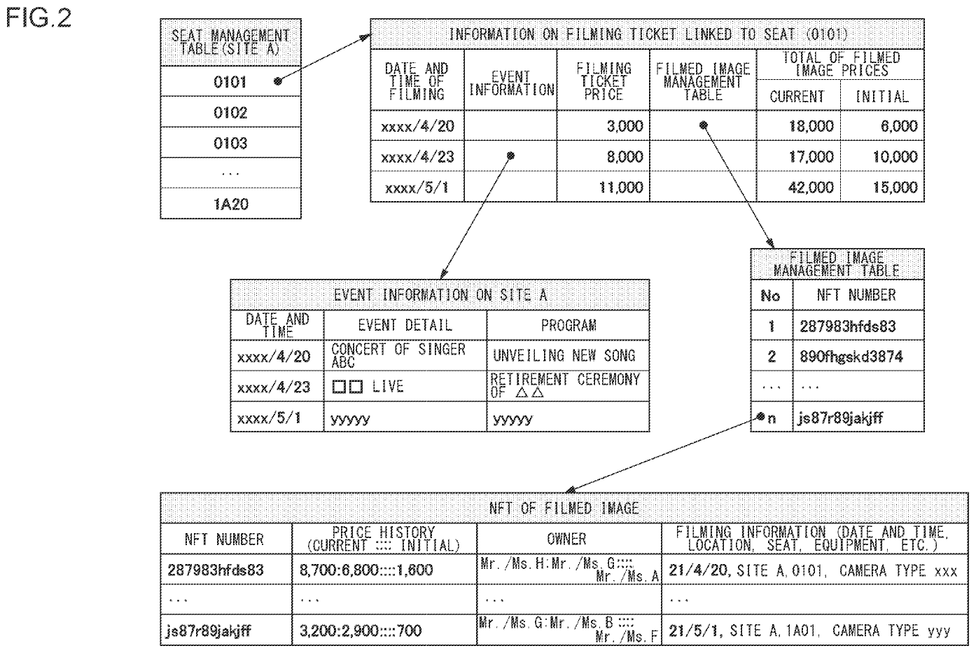

FIG. 2 shows how various information managed by the database 30 or the block chain is associated with each other.

The seat management table of site A stores other seat information not illustrated here, associating the other seat information with seat identification numbers such as “0101”. Each seat identification number includes information on a filming ticket linked to the seat. In this case, information on the filming ticket linked to the seat identification number “0101” is illustrated.

The information on the filming ticket linked to the seat includes the date and time of filming, pointer to event information, filming ticket price, pointer to a filmed image management table, and initial and current total prices of filmed images.

For example, the first entry in the information on the filming ticket lined to the seat “0101” includes the date and time of filming “xxxx/4/20”, pointer to event information on the date and time of filming, filming ticket price “3,000 yen”, pointer to the filmed image management table, current total price of filmed images “18,000 yen”, and initial total price of filmed images “6,000 yen”.

The event information on site A includes the date and time of event, event detail, and program. For example, the date and time “xxxx/4/20”, event detail “concert of singer ABC”, and program “unveiling a new song” are stored in the first entry in the event information on site A.

The filmed image management table stores NFT numbers from No. 1 to No. n. This is a table that manages a total of n filmed images as NFTs on a block chain in distributed management. The NFT of a filmed image stores, in association with the NFT number, a history of the price of the filming ticket from initial to current, a history of ownership, and filming information. For example, the NFT number “287983hfds83” is associated with a history from the initial price “1,600 yen” to the current price “8,700 yen” of the filmed image, a history from the initial owner “Mr./Ms. A” to the current owner “Mr./Ms. H”, and filming information comprised of the date and time of filming “21/4/20”, filming site “site A”, seat “0101”, camera type “xxx” and is recorded on a block chain.

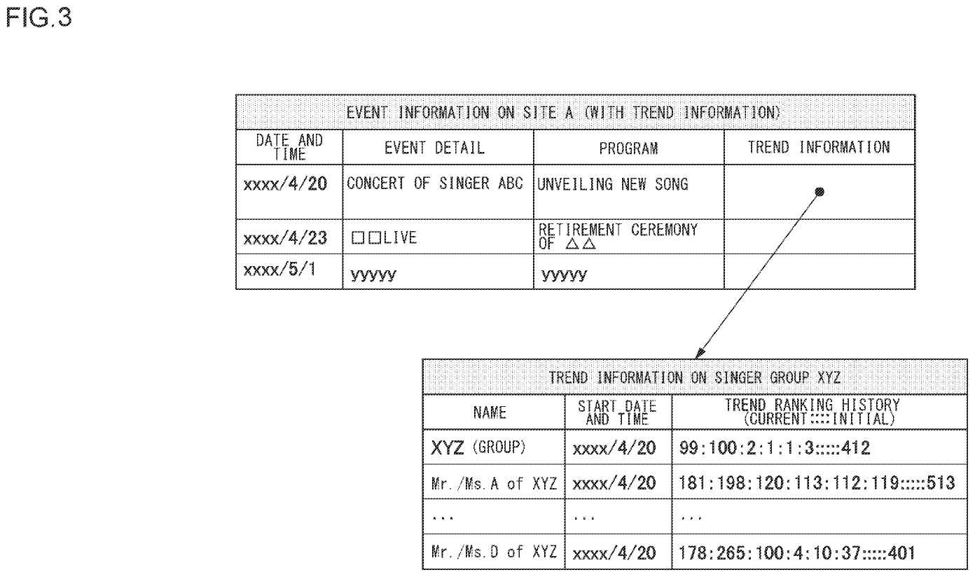

FIG. 3 shows another example of event information. Unlike the case of FIG. 2, the event information on site A includes trend information. For example, the date and time “xxxx/4/20”, event detail “concert of singer ABC”, program “unveiling a new song”, and pointer to trend information on a singer group XYZ are stored in the first entry in the event information on site A. The trend information on the singer group XYZ includes the date and time when the trend of the singer group XYZ started to be recorded and a history of trend ranking. For example, the trend ranking history of the singer group XYZ indicates that the group was ranked 412th initially but ranks 99th currently. The trend ranking history of Mr./Ms. A of the singer group XYZ indicates that Mr./Ms. A ranked 513rd initially but ranks 181st currently. It is possible to predict who of the singer group XYZ captured in the image will be priced high by referring to the trend ranking history in the trend information.

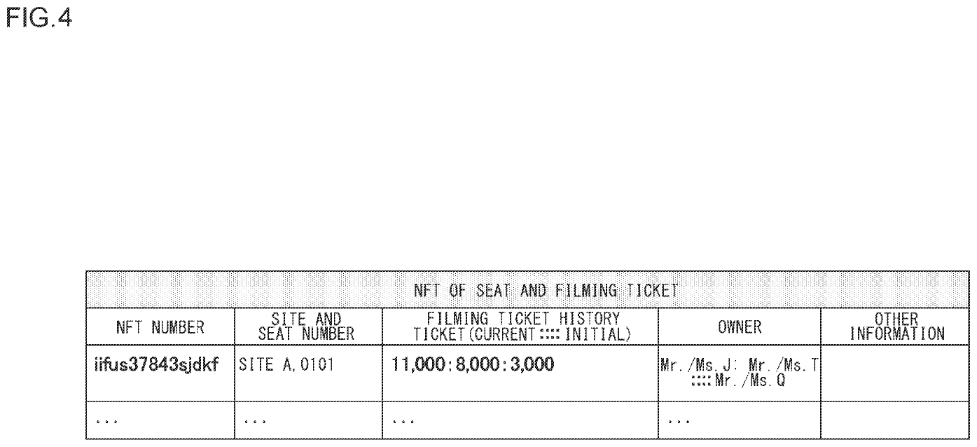

FIG. 4 illustrates an NFT of a filming ticket linked to a seat. The NFT of a filming ticket includes an NFT number, site and seat number, price history of the filming ticket from initial to current, history of ownership, and other information. For example, the NFT number “iifus37843sjdkf” is associated with site “A” and a seat number “0101”, a history from the initial price “3,000 yen” to the current price “11,000 yen” of the filming ticket, a history from the initial owner “Mr./Ms. Q” to the current owner “Mr./Ms. J”, and other information and is recorded on the block chain.

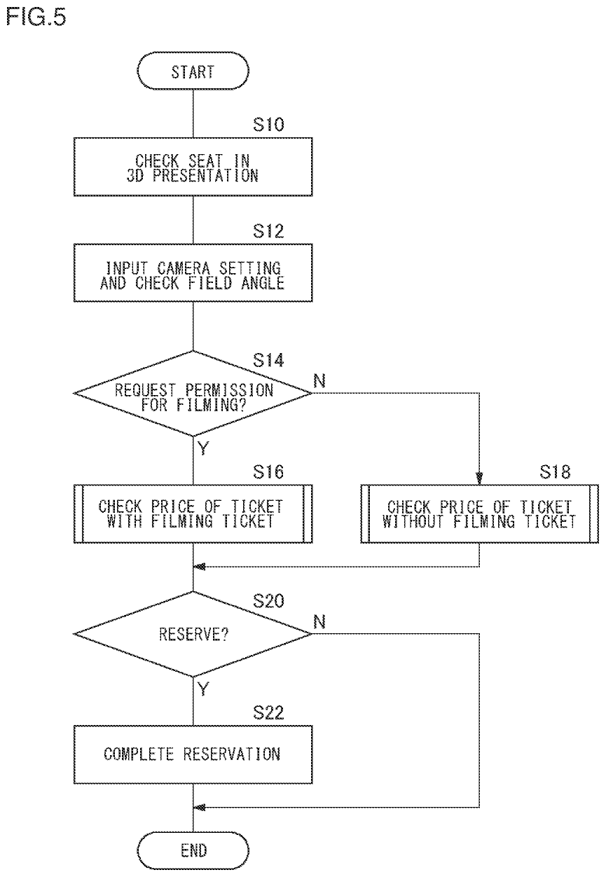

FIG. 5 is a flowchart illustrating a procedure whereby a purchaser reserves a ticket.

The purchaser checks the seat and the condition of the field of view available when the stage is seen from the seat in a three-dimensional presentation (S10). The purchaser inputs setting information on the camera used for filming to check the field angle (S12).

The purchaser inputs whether to request permission for filming (S14). When the purchaser requests permission for filming (Y in S14), the purchaser checks the price of a ticket with a filming ticket (S16). When the purchaser does not request permission for filming (N in S14), the purchaser checks the price of a ticket without a filming ticket (S18).

After checking the ticket price, the purchaser inputs whether to reserve the ticket (S20). When the purchaser reserves the ticket (Y in S20), the purchaser completes reservation, whereupon the ticket is issued (S22).

When the purchaser does not reserve the ticket (N in S20), the ticket is not issued, and the procedure is terminated.

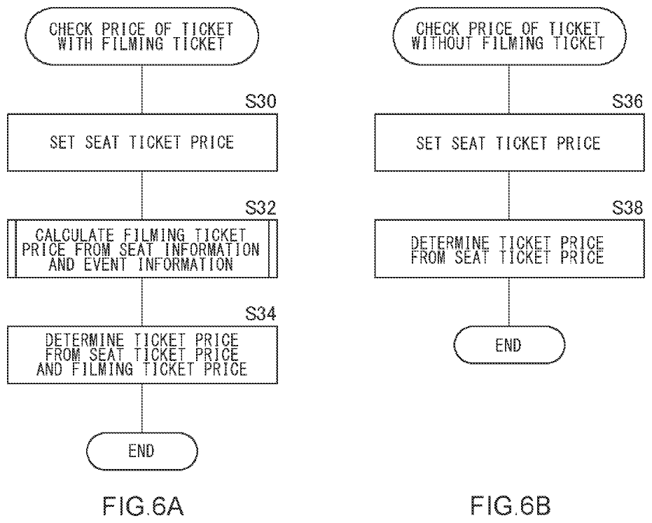

FIG. 6A is a flowchart illustrating a detailed procedure of step S16 of FIG. 5 for checking the price of a ticket with a filming ticket, and FIG. 6B is a flowchart illustrating a detailed procedure of step S18 of FIG. 5 for checking the price of a ticket without a filming ticket.

The flowchart of FIG. 6A for checking the price of a ticket with a filming ticket will be described. The price determination unit 20 sets a seat ticket price (S30). The price determination unit 20 calculates a filming ticket price from the seat information and the event information (S32). The price determination unit 20 determines the price of a ticket with a filming ticket from the seat ticket price and the filming ticket price (S34).

The flowchart of FIG. 6B for checking the price of a ticket without a filming ticket will be described. The price determination unit 20 sets a seat ticket price (S36). The price determination unit 20 determines the price of a ticket without a filming ticket from the seat ticket price (S38).

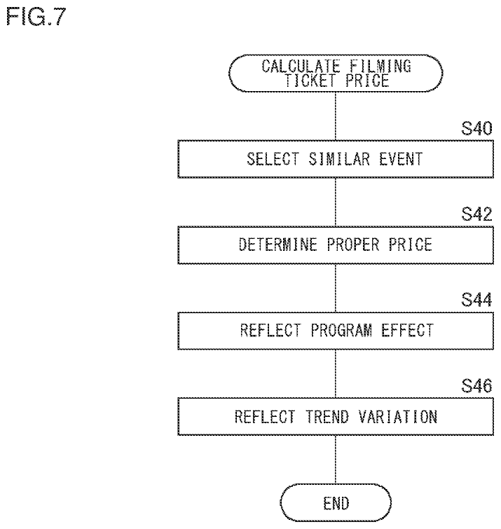

FIG. 7 is a flowchart illustrating a detailed procedure of step S32 of FIGS. 6A and 6B for calculating the filming ticket price.

The price determination unit 20 selects a similar event and calculates the filming ticket price based on the similar event (S40). A similar event is an event in the past related to the artist who is filmed. More specifically, the price determination unit 20 searches a history for the same artist in the past. If the same artist is not found in the history, the price determination unit 20 refers to a ranking of artists searched for in a search engine to find historical information on other artists who are closely related to the target artist (for example (e.g., artists who belong to the same group as the target artist) or refers to a reference price table for artists that is separately maintained. Thereby, the price determination unit 20 determines the filming ticket price.

The price determination unit 20 determines the current right price by referring to the past price history of the filmed image (S42).

The price determination unit 20 reflects the program effect in the filming ticket price (S44). For example, the price determination unit 20 multiplies the filming ticket price by a weighting coefficient in accordance with retirement of an artist or unveiling of a new song, thereby updating the filming ticket price.

The price determination unit 20 reflects the variation in the trend associated with the filmed person in the filming ticket price (S46). For example, the price determination unit 20 uses a search keyword ranking in a search site and multiples a weighting coefficient for variation in the trend associated with the artist by the filming ticket price, thereby updating the filming ticket price.

The above-described various processes in the ticket price determination apparatus 100 can of course be implemented by hardware-based apparatus such as a CPU and a memory and can also be implemented by firmware stored in a read-only memory (ROM), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

In the embodiment of the present invention, it is described that the price determination unit 20 determines the price of a filming ticket associated with a seat where filming is permitted in accordance with a situation of variation in the value of the image filmed from the seat where filming is permitted. However, information for identifying the position where the image is filmed may not be the seat but a viewer box, a partition, a space in the site. The price of a filming ticket may be determined by associating the information identifying a position where filming is permitted with the filmed image. In this case, the seat recommendation unit 90 of the embodiment will be a position recommendation unit.

As described above, the ticket price determination apparatus 100 of the embodiment of the present invention can dynamically determine, when one purchases a ticket comprised of a seat ticket and a filming ticket for a concert or the like at a site that includes an area in which filming is permitted and for which use, sales, and purchase of filmed images are permitted, the price of the ticket dynamically in consideration of information such as which seat has allowed filming a valued image, how much it was sold in the past, how high it is currently valued, or the like. This allows providing a right price of a filming ticket associated with a seat in real time.

It is also possible to recommend to a ticket purchaser a seat for which the value of the filmed image is expected to be high, based on information such as the density of filming persons, past image values, and impact of an obstacle in the filming, while considering the situation of purchase of filming tickets linked to seats. Receiving a recommendation for a location of filming makes it possible to avoid dilution of the image value and prevent the value of the filmed image from being lowered.

Described above is an explanation based on an exemplary embodiment. The embodiment is intended to be illustrative only and it will be understood by those skilled in the art that various modifications to combinations of constituting elements and processes are possible and that such modifications are also within the scope of the present invention.

What is claimed is:

1. A ticket price determination apparatus comprising:
a database that stores a value of an image filmed from a position in a site where filming is permitted, mapping the value to the position;
a price variation monitoring unit that monitors a variation in the value of the image filmed from the position where filming is permitted; and
a price determination unit that determines a price of a filming ticket associated with the position where filming is permitted, in accordance with the variation in the value of the image filmed from the position where filming is permitted.

2. The ticket price determination apparatus according to claim 1, further comprising:
a position recommendation unit that recommends the position where filming is permitted based on a density of filming persons in the site determined by a situation of purchase of filming ticket for the site or based on a condition of field of view determined by an obstacle in filming.

3. The ticket price determination apparatus according to claim 1, wherein
the apparatus refers to a history of a price of an image filmed from the position where filming is permitted, by managing images filmed from the position where filming is permitted as non-fungible tokens on a block chain in distributed management.

4. A ticket price determination method comprising:
referring to a database that stores a value of an image filmed from a position in a site where filming is permitted, mapping the value to the position, and monitoring a variation in the value of the image filmed from the position where filming is permitted; and
determining a price of a filming ticket associated with the position where filming is permitted, in accordance with the variation in the value of the image filmed from the position where filming is permitted.

5. A ticket price determination program comprising computer-implemented modules including:
a module that refers to a database that stores a value of an image filmed from a position in a site where filming is permitted, mapping the value to the position, and monitors a variation in the value of the image filmed from the position where filming is permitted; and
a module that determines a price of a filming ticket associated with the position where filming is permitted, in accordance with the variation in the value of the image filmed from the position where filming is permitted.
